(19) United States
(12) Patent Application Publication
(10) Pub. No.: US 2025/0388112 A1
(43) Pub. Date: Dec. 25, 2025

(54) SYSTEM FOR OPTIMIZING ELECTRIC VEHICLE CHARGING SCHEDULES AND IMPROVING ACCURACY OF PREDICTING GREENHOUSE GAS EMISSIONS OF ELECTRIC VEHICLE CHARGING BASED ON TRANSFER LEARNING AND DEEP REINFORCEMENT LEARNING

(71) Applicant: MING CHUAN UNIVERSITY, TAIPEI (TW)

(72) Inventor: DAVID CHUNHU LI, TAOYUAN COUNTY (TW)

(21) Appl. No.: 18/790,579

(22) Filed: Jul. 31, 2024

(30) Foreign Application Priority Data
Jun. 21, 2024 (TW) 113123288

(51) Int. Cl. B60L 53/62; G06Q 10/0631

(52) U.S. Cl. CPC B60L 53/62; G06Q 10/06311

(57) ABSTRACT

A system for optimizing electric vehicle (EV) charging schedules and improving the accuracy of predicting greenhouse gas emissions from EV charging by using transfer learning and DDPG includes a mixed-integer linear programming (MILP) optimization module, a reinforcement learning (RL) module, a climate prediction module, an EV charging capacity prediction module, a transfer learning (TL) module, and an integration and control module, so as to integrate transfer learning, MILP, and RL. Based on MILP solutions and through RL agent-operated dynamic scheduling decisions, the knowledge of predicting EV charging capacity is transformed into predictions of greenhouse gas reduction. Ultimately, the integration and control module maximizes system performance, including reducing charging-related greenhouse gas emissions and minimizing costs to meet charging demands, thereby optimizing the charging schedules and accurately predicting the greenhouse gas reduction at charging stations.

### TECHNICAL FIELD

The present disclosure relates to a system for optimizing electric vehicle (EV) charging schedules and improving the accuracy of predicting greenhouse gas emissions (GHG) of electric vehicle charging based on transfer learning and deep reinforcement learning, and more particularly relates to the system that integrates Transfer Learning (TL), Mixed-Integer Linear Programming (MILP), and Reinforcement Learning (RL) to optimally adjust the charging schedules and accurately predict their corresponding greenhouse gas emissions at each point in time.

### BACKGROUND OF THE DISCLOSURE

As the urgent goal of mitigating climate change requires global attention to greenhouse gas (GHG) emission reduction, more and more countries are turning to vehicle electrification as a core strategy for carbon reduction; among them, electric vehicles (EVs) are increasingly recognized as a greener alternative to traditional internal combustion vehicles, prompting individuals and businesses to increasingly turn to EVs, thereby increasing the demand for efficient and sustainable charging infrastructure and services. The widespread adoption of EVs depends on the development of such charging infrastructure and services. Forecasts indicate that EVs will account for 3.9% of global electricity demand by 2030, with Europe projected to account for more than 6% of that demand.

Non-EU countries are encourage to reduce greenhouse gas emissions, prevent the risk of carbon leakage, reduce global greenhouse gas emissions, and make a significant contribution to the implementation of the EU's and global climate goals. The EU's Carbon Border Adjustment Mechanism (CBAM) is scheduled for initial implementation in October 2023 and has become a key regulatory framework for international trade. CBAM explicitly requires all importers in the EU to provide a comprehensive report detailing the carbon content of their exports by the fourth quarter of 2023. In addition, on Aug. 7, 2023, the Taiwan Carbon Exchange (TCX) was officially established in the Kaohsiung Software Park, marking the beginning of the “Carbon Trading Era” in Taiwan. TCX is positioned to help companies address potential upcoming challenges such as carbon taxes, carbon fees or consumer demand, which includes actively participating in carbon inventories and working all together to reduce carbon emissions.

In response to the impacts of climate change and the implementation of carbon tariffs, governments and corporations around the world are proactively developing greenhouse gas emission inventories and forecasts. These efforts provide an important reference for the formulation of carbon pricing, carbon tariffs and policies related to the realization of net-zero carbon emissions. Therefore, the accurate prediction of greenhouse gas reduction associated with electric vehicle charging is in line with the current development trend of the industry and is of important research significance.

Furthermore, as electric vehicle manufacturers and charging infrastructure operators conduct inventory assessment and greenhouse gas emission forecasts, the maximum strategic optimization of greenhouse gas emission while meeting electric vehicle charging demand has become a key concern for enterprises to achieve sustainable development. Therefore, the in-depth research on this topic will help policy makers and industry leaders to make wise decisions on incentives, regulatory frameworks, and infrastructure development, thereby contributing to the academic discussions on sustainability.

However, there is a limited amount of research data related to EV charging and carbon emissions, where transfer learning has proven to be a powerful technique in machine learning, allowing a model trained on one task to be applied to another related task with limited data. Applying transfer learning to the prediction of carbon emission reduction in electric vehicle charging may produce more accurate models with less training data, and may also overcome the problem of limited availability of data on electric vehicle charging and carbon emission reduction in the real world.

Despite the growing interest in electric vehicles and their environmental impacts, there is still a research gap in understanding the full extent of the carbon reduction potential of the charging process.

The importance and significance of carbon reduction in the charging process includes the following aspects.
1. Environmental Impacts: Climate change and greenhouse gas emissions are pressing global issues; electric vehicles are seen as a promising solution for reducing emissions from transportation; accurate prediction of greenhouse gas reductions from electric vehicle charging can contribute to more sustainable transportation practices, which are critical to mitigating climate change.
2. Policies and Regulations: Many governments and regions have set targets for reducing greenhouse gas emissions and often encourage the use of electric vehicles to achieve these targets; accurate predictions of emission reductions from electric vehicle charging can provide information to policymakers and regulatory authorities and help them to design effective policies and regulations to promote the use of electric vehicles.
3. Consumer Adoption: Understanding the environmental benefits of electric vehicles can encourage more individuals and businesses to adopt the electric vehicles, and providing consumers with reliable information on the greenhouse gas reduction potential of electric vehicles can increase the adoption rate of electric vehicles, which in turn can help reduce overall greenhouse gas emissions.
4. Charging Infrastructure Optimization: It is important for electric vehicle charging infrastructure planners and operators to understand how different charging strategies affect greenhouse gas emission, and reinforcement learning (RL) in transfer learning (TL) can help optimize charging infrastructure and operations to minimize greenhouse gas emission.
5. Resource Allocation: Resources can be allocated more efficiently by accurately predicting greenhouse gas reductions; for example, utility companies can better plan for the increased demand for electricity from electric vehicle charging and ensure that additional power generation comes from low-carbon or renewable sources.

In recent years, the urgent global concern over climate change has spurred research in various fields that aim at mitigating environmental impacts.

### [Greenhouse Gas Emission Analysis and Prediction]

A study of electric vehicles in different states of the United States examines the correlations between battery degradation and energy use and greenhouse gas emissions, providing models and empirical data for wise policy decisions; it examines how degradation affects emissions and energy consumption, and conducts sensitivity analyses of factors such as travel demand, power structure, degradation limitations, and battery capacity; the analysis identifies the factors that mostly affect greenhouse gas emissions and energy use for each battery; it uses regression and smoothing models to predict greenhouse gas emissions in North America and demonstrates the robustness of the high coefficient of certainty; and the study emphasizes the importance of emissions from road transportation, and highlights the economic and health impacts and the need to quantify and reduce these emissions.

In other studies, an integrated approach combining Multiple Linear Regression (MLR) and Multi-variate Polynomial Regression (MPR) is used to project CO₂ emissions in 2030 under various scenarios. Forecasts of population, gross domestic (GDP), energy use and electricity sources provide an overall view of the factors affecting emissions. In other studies, LSTM3, a deep learning framework using Long Short-Term Memory (LSTM) network, is used for greenhouse gas emission prediction, and its performance is compared with that of the Autoregressive Integrated Moving Average model (ARIMA) and clustering model. They systematically evaluate the prediction variables, finding that speed, density, greenhouse gas emission rate and linkage speed are the key to LSTM models.

In other studies, the energy efficiency, emissions, and cost-effectiveness of electric vehicles are studied, and the life-cycle emissions and cost models are created. It has been found that the carbon emissions from electric vehicles have been reduced by 47% compared to gasoline vehicles, primarily due to the significant reduction in emissions during use, and this highlights the environmental benefits of electric vehicles, and supports efforts to reduce the global carbon footprints.

### [Reinforcement Learning (RL) Optimizes Electric Vehicle Charging Schedule]

In some studies, a Text-based Deep Policy Gradient (TDDPG), an approach that combines Deterministic Policy Gradient (DDPG) algorithm and Transfer Learning (TL) for adaptive electric vehicle charging strategies, is introduced. The TDDPG improves the accuracy of policy evaluation and forms an optimized Markov decision process framework to simulate and verify its efficacy by demonstrating the reduction of anomalies in the charging policy, which satisfies user needs more efficiently and accelerates strategic development. In other literature, multi-agent deep reinforcement learning (MADRL) has been used to solve the electric vehicle charging problem in smart grids by efficiently scheduling the charging of multiple electric vehicles in a decentralized smart grid setup, so that each vehicle can make quick decisions; its combination of centralized training and decentralized execution is superior to existing methods and ensures that multiple electric vehicles receive optimal energy at each step, thus optimizing scheduling and decision making. This approach efficiently schedules multiple electric vehicles in a decentralized smart grid setup, thus enabling each vehicle to make quick decisions; it combines centralized training and decentralized execution, which is superior to existing methods, and ensures that multiple electric vehicles receive the optimal amount of energy at each step, so as to optimize scheduling and minimize costs.

In addition, an intense learning approach of optimizing electric vehicle charging and pricing at public stations is also provided in existing studies, which responds to the time-varying continuous space by focusing on the total charging rate to satisfy the departure time requirement, and introduces a characteristic-based linear function to improve the efficiency and generalization of the state value function. When simulated with real data, the profit of the charging stations is increased by 138.5%.

In existing studies, the multi-agent reinforcement learning (MARL) has also been used to address the complexity of electric vehicle charging scheduling in urban environments and resolve the inherent gaming problem. Their proposed framework integrates the cooperative vehicle infrastructure system (CVIS) to manage the dynamics between charging pile and electric vehicle; they introduced an NCG-MA2C algorithm, a novel multi-agent A2C algorithm for large-scale networks. The algorithm is presented by the nearest-neighbor multi-head attention state, and thus it is adaptive to pricing strategies and space-time discount joint rewards to achieve stable learning. The NCG-MA2C algorithm outperforms the standards and enhances the efficiency of the charging pile and lower the charging cost.

In the related art, the scheduling problem is built into a Constrained Markov Decision Process (CMDP) by formulating the optimal electric vehicle charging and discharging schedules for the response to the smart grid demand, taking into account the arrival, departure, energy and electricity price of electric vehicles. A symbolic deep reinforcement learning (SDRL), a model-free approach, is introduced, the optimal schedule can be determined without the need of prior knowledge of randomness or manual adjustments. Compared with benchmark solutions, this approach effectively satisfies billing constraints and reduces billing costs.

### [Transfer Learning (TL) Time Series Prediction]

Existing studies also propose a TrEnOS-ELMK algorithm, which is a new hybrid algorithm that combines transfer learning (TL) with Online Sequential Extreme Learning Machine (OS-ELMK) for forecasting time sequence, and strategically uses past data to enhance robustness and predictability without discarding historical information. This combination overcomes the limitations of OS-ELM and uses past experience to achieve better performance. In other studies, a DTr-CNN is proposed, which is a deep transfer learning (TL) framework that uses Convolutional Neural Network (CNN) and causal convolution to achieve prediction accuracy without requiring future data. This method integrates transfer learning (TL) into feature learning to identify patterns of target tasks from source data; and uses the divergence of the Dynamic Time Warping (DTW) algorithm and the Jensen-Shannon (JS) to resolve the challenges for cross-dataset transmission and to select relevant source domains that minimize differences and thus improve applicability in real-world scenarios.

In the current researches, there are still some unresolved issues and challenges. The intricate interactions between battery degradation, energy consumption and greenhouse gas (GHG) emissions present complexities worthy of further exploration. It is noteworthy that some studies have focused on specific areas, highlighting the challenge of formulating models that exhibit robust generalization across diverse geographical and regulatory contexts. With the emergence of the promising reinforcement learning (RL) methods, the transition of electric vehicle charging infrastructure from simulated environment to reality poses considerable challenges.

Furthermore, a general trend in many studies is to consider a single electric vehicle or charging station, and solving the scalability issues associated with large-scale deployment and ensuring seamless coordination in complex urban environments is still an open and urgent issue. The main task of selecting appropriate source domains for transfer learning (TL) remains a challenge, requiring careful consideration on the similarity index between domains and optimization of knowledge transfer. Adapting transfer learning (TL) models to dynamic changes in data distribution over time poses ongoing challenges, especially when the correlation between the source domain and the target task is uncertain.

In view of the aforementioned problems, the present discloser further conducted researches on the integration of transfer learning (TL) and reinforcement learning (RL) for the adjustment of charging plans, and the prediction of greenhouse gas emissions from charging, and developed a system of the present disclosure in the hope of solving the above problems.

### SUMMARY OF THE DISCLOSURE

It is a primary objective of the present disclosure to overcome the above problems of the related art by disclosing a system for optimizing electric vehicle charging schedules and improving the accuracy of predicting greenhouse gas emissions based on transfer learning and deep reinforcement learning, which includes: a mixed-integer linear programming (MILP) optimization module, for inputting usage data of at least one charging facility, so as to optimize the charging behavior of the charging facility and establish a charging schedule based on the reduction of greenhouse gas emissions; a reinforcement learning (RL) module, for inputting charging data and climate conditions of the charging facility, so as to adjust the charging schedule according to the interactivity of the charging data and the climate conditions; a climate prediction module, for inputting meteorological data obtained at the location of the charging facility, so as to predict a meteorological change occurred at the location of the charging facility according to a time sequence, and integrate the climate conditions to let the reinforcement learning (RL) module dynamically adjust the charging schedule; an electric vehicle charging capacity prediction module, for inputting charging demand data of the charging facility, so as to predict the charging demand of the charging facility according to the time sequence, and generate a charging prediction information accordingly; a transfer learning (TL) module, for integrating the outputs of the mixed-integer linear programming (MILP) optimization module and the reinforcement learning (RL) module, using the charging prediction information as a supplementary variable, and predicting the reduction of greenhouse gas emissions; and an integration and control module, linked to the mixed-integer linear programming (MILP) optimization module, the reinforcement learning (RL) module, the climate prediction module, the electric vehicle charging capacity prediction module and the transfer learning (TL) module, so as to adjust the charging schedule according to the usage data of the charging facility, the charging data, the meteorological data, the charging demand data, the charging prediction information, the supplementary variable and predicted greenhouse gas reduction.

In the system for optimizing electric vehicle charging schedules and improving the accuracy of predicting greenhouse gas emissions based on transfer learning and deep reinforcement learning, the usage data include at least one of the available capacity, charging rate, remaining capacity, charging price, and greenhouse gas emission of the charging facility.

In the system for optimizing electric vehicle charging schedules and improving the accuracy of predicting greenhouse gas emissions based on transfer learning and deep reinforcement learning, wherein, the charging data include at least one of the failure rate or the charging price of the charging facility.

In the system for optimizing electric vehicle charging schedules and improving the accuracy of predicting greenhouse gas emissions based on transfer learning and deep reinforcement learning, the mixed-integer linear programming (MILP) optimization module establishes a charging schedule based on a mixed-integer linear programming (MILP) function f(x) as given in Equation (1):

$$f ( x ) = Minimize ( {\sum }_{i = 1}^{N} {\sum }_{j = 1}^{K} {\sum }_{t = 1}^{M} {C}_{emissions} ( t ) \cdot {X}_{ijt} \cdot {P}_{t} + {\sum }_{j = 1}^{K} {\sum }_{t = 1}^{M} {P}_{t} \cdot {Y}_{jt} \} ; \qquad ( Equation 1 )$$

where, Cₑₘᵢₛₛᵢₒₙₛ(t) is the carbon emissions from power generation of the charging facility at the charging time t; Xᵢⱼₜ is a decision variable, which is a non-negative variable for each an electric vehicle i at the charging time t of a charging station j; Pt is the charging price of the charging facility; and Yⱼₜ is a function of whether or not the charging station j is used at the charging time t.

In the system for optimizing electric vehicle charging schedules and improving the accuracy of predicting greenhouse gas emissions based on transfer learning and deep reinforcement learning, the reinforcement learning (RL) module defines a learning function that defines a state space and an action parameter, the state space is a combination of the charging data and the corresponding climate condition, the action parameter is for an adjustment of the charging schedule, and the learning function responds to the amount greenhouse gas reduction when the action parameter is executed and the state space is presented.

In the system for optimizing electric vehicle charging schedules and improving the accuracy of predicting greenhouse gas emissions based on transfer learning and deep reinforcement learning, the learning function obtains the maximum value of the greenhouse gas reduction in the state space of the learning function by defining a reward factor and a discount factor.

In the system for optimizing electric vehicle charging schedules and improving the accuracy of predicting greenhouse gas emissions based on transfer learning and deep reinforcement learning, wherein, the reinforcement learning (RL) module further defines a reward function Rᵢₜ as given in Equation 2 below:

$${R}_{it} = {\sum }_{t = 1}^{M} {E}_{{pred}_{t}} - λ \times {\sum }_{t = 1}^{M} {X}_{ijt} , ∀ i = 1 , … , N , \\ j = 1 , … , K , t = 1 , … , M ; \qquad ( Equation 2 )$$

where, E_{predt} is a predicted greenhouse gas reduction; and A is an adjustment parameter.

In the system for optimizing electric vehicle charging schedules and improving the accuracy of predicting greenhouse gas emissions based on transfer learning and deep reinforcement learning, the learning function Q (Sₜ, Aₜ) is given in Equation 3 below:

$$Q ( {S}_{t} , {A}_{t} ) = 𝔼 [ {R}_{t + 1} + γ {max}_{{A}_{t + 1}} Q ( {S}_{t + 1} , {A}_{t + 1} ) \vert {S}_{t} , {A}_{t} ] ; \qquad ( Equation 3 )$$

where, Rₜ₊₁ is a reward factor of the greenhouse gas reduction at the time t+1; and γ is a discount factor.

In the system for optimizing electric vehicle charging schedules and improving the accuracy of predicting greenhouse gas emissions based on transfer learning and deep reinforcement learning, the learning function updates the reinforcement learning (RL) according to Equation 4 below:

$$Q ( {S}_{t} , {A}_{t} ) ← Q ( {S}_{t} , {A}_{t} ) + α [ {R}_{t + 1} + γ {max}_{{A}_{t + 1}} Q ( {S}_{t + 1} , {A}_{t + 1} ) - Q ( {S}_{t} , {A}_{t} ) ] ; \qquad ( Equation 4 )$$

where, α is a defined learning rate.

In the system for optimizing electric vehicle charging schedules and improving the accuracy of predicting greenhouse gas emissions based on transfer learning and deep reinforcement learning, the transfer learning (TL) module defines a transfer learning (TL) target function to predict the greenhouse gas reduction; and the transfer learning (TL) target function F₂ is given in Equation 5:

$${F}_{2} = Minimize {\sum }_{i = 1}^{N} {\sum }_{j = 1}^{K} {\sum }_{t = 1}^{M} {C}_{emissions} \cdot {P}_{t} \cdot {X}_{ijt} + {\sum }_{t = 1}^{T} {( {G}_{t} - {E}_{{pred}_{t}} )}^{2} + {\sum }_{i = 1}^{N} {\sum }_{t = 1}^{M} {X}_{ijt} \cdot {E}_{{pred}_{t}} ; \qquad ( Equation 5 )$$

where, E_{predt} is the predicted amount of greenhouse gas emissions of each electric vehicle i.

From the above description and settings, it is obvious that the present disclosure mainly has the advantages and effects as detailed below:
1. While existing researches have profoundly studied the application of reinforcement learning (RL) in electric vehicle charging and transfer learning (TL) in time sequence, the present disclosure integrates its elements to explore how deep reinforcement learning (RL) can effectively transfer the knowledge obtained from a charging environment to another charging environment. In addition, a mechanism for dynamically adjusting the charging policy based on real-time factors such as climate factor, charging price, charging pile failure factor, etc. is further added. This function enhances the adaptability of the proposed model to different operating environments. It is noteworthy that most existing researches mainly focus on individual electric vehicles; on the other hand, the present disclosure expands its scope by considering a diverse fleet of electric vehicles with different properties and charging requirements to broaden and enrich its comprehensiveness and practical application.
2. The present disclosure provides insights into the potential of carbon reduction during a charging process to timely address current and significant issues related to sustainability, energy and transportation, and to understand and optimize the environmental benefits of electric vehicle adoption by reducing the carbon footprint associated with charging, and the use of transfer learning to predict reductions in greenhouse gas emissions during charging of EVs through the use of reinforcement learning is an important and significant issue.

### BRIEF DESCRIPTION OF THE DRAWINGS

FIG. 1 is a block diagram showing the system architecture of the present disclosure;

FIG. 2 is a graph showing the historical temperature changes in Palo Alto, California, United States from 2012 to 2021;

FIG. 3a is a graph showing the historical changes in the charging capacity and greenhouse gas savings of electric vehicles in Palo Alto, California, U.S.A. from 2012 to 2021;

FIG. 3b is a graph showing the historical changes in the cumulative EV charging capacity and cumulative greenhouse gas reduction of electric vehicles in Palo Alto, California, from 2012 to 2021;

FIG. 4a is a 3D graph showing the impact of maximum temperature and electric vehicle charging capacity on greenhouse gas reduction in Palo Alto, California, USA from 2012 to 2021;

FIG. 4b is a 3D graph showing the impact of average temperature and EV charging capacity on the cumulative reduction of greenhouse gases in Palo Alto, California, USA from 2012 to 2021;

FIG. 5a is a graph showing the distribution of monthly greenhouse gas emission reductions and electric vehicle charging capacity changes at the charging station (Palo Alto, CA/BRYANT #1) before optimizing the electric vehicle charging schedule;

FIG. 5b is a graph showing the distribution of monthly greenhouse gas emission reductions and electric vehicle charging capacity changes at the charging station (Palo Alto, CA/BRYANT #1) after optimizing the electric vehicle charging schedule;

FIG. 6a is a graph showing the greenhouse gas emission reductions of the top five charging stations after optimizing the charging schedule of electric vehicles;

FIG. 6b is a graph showing the percentage increase in greenhouse gas emission reduction of the top five charging stations after optimizing the electric vehicle charging schedule;

FIG. 7a is a 3D graph showing the charging costs for all electric vehicle users without the optimization of the charging schedule;

FIG. 7b is a 3D graph showing the charging costs for all electric vehicle users with the optimization of the charging schedule;

FIG. 8a is a graph showing the average percentage reduction in monthly charging costs after optimizing the charging schedule of electric vehicles;

FIG. 8b is a graph showing the improvement in average monthly greenhouse gas emission reductions after optimizing the electric vehicle charging plan;

FIG. 9a is a histogram showing the comparison of MAEs predicted by the greenhouse gas emission models;

FIG. 9b is a histogram showing the comparison of three indexes of the greenhouse gas emission models;

FIG. 10 is a comprehensive comparison chart of the overall accuracy of the greenhouse gas emission model prediction;

FIG. 11a is a graph showing the comparison of cumulative Ev charging costs of the charging schedules between the related art and the present disclosure;

FIG. 11b is a graph showing the comparison of cumulative greenhouse gas reduction of the charging schedules between the related art and the present disclosure.

FIG. 12a is a graph showing the annual cumulative greenhouse gas emission reductions achieved using a conventional EV charging schedule; and

FIG. 12b is a graph showing the annual cumulative greenhouse gas emission reductions achieved using an optimized EV charging schedule.

### DETAILED DESCRIPTION OF THE PREFERRED EMBODIMENTS

The technical characteristics of the present disclosure are described in detail by several preferred embodiments accompanied with related drawings, so that everyone can have thorough understanding and agreement with the present disclosure.

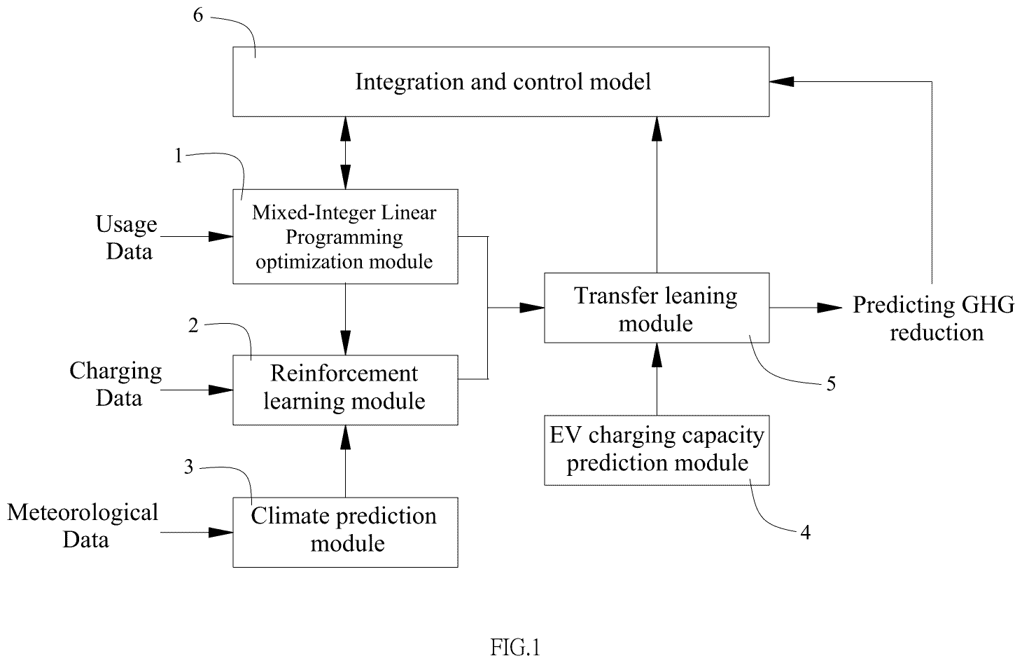

With reference to FIG. 1 for a system for optimizing electric vehicle charging schedules and improving the accuracy of predicting greenhouse gas emissions based on transfer learning and deep reinforcement learning in accordance with the present disclosure, and its primary objective is to optimize the charging schedule of the electric vehicle charging station, thereby improving the accuracy of predicting the amount of greenhouse gas savings in charging activities; and the present disclosure pursues a dual-goal to minimize the amount of greenhouse gas emission and effectively satisfy the users' charging demand while ensuring accurate prediction of emissions reductions brought about by these optimizations

The present disclosure uses the technologies mixed-integer linear programming (MILP) and reinforcement learning (RL) to complexly manage the charging schedule, while using the transfer learning (TL) method to improve the emission prediction accuracy of using historical data.

Firstly, the present disclosure defines Xᵢⱼₜ standing for the charging capacity (kWh) of a charging station j for an electric vehicle i in the time interval t; Cₑₘᵢₛₛᵢₒₙₛ(t) standing for the carbon emissions from power generation of the charging facility at the charging time t; ΣᵢΣⱼΣₜ(Cₑₘᵢₛₛᵢₒₙₛₜ(t)·Xᵢⱼₜ) standing for the total greenhouse gas emission related to the power consumed by the electric vehicle according to the charging schedule; and ΣᵢΣⱼΣₜ(GHG_Reductionᵢⱼₜ) standing for the expected greenhouse gas reductions achieved through optimized charging plans determined by MILP and RL while minimizing errors in predicting these reductions, where the multi-objective optimization problem can be expressed mathematically expressed in the Mathematical Equation 1 below:

$$[ Mathematical Equation 1 ]$$

$$\begin{matrix}Maximize : {\sum }_{i} {\sum }_{j} {\sum }_{t} {GHG\_Reduction}_{ijt} - λ \cdot E \\ Subject to : {\sum }_{i} {\sum }_{j} {\sum }_{t} {C}_{emissions} ( t ) \cdot {X}_{ijt} \leq M\end{matrix}$$

where, E stands for the predicted reduction error, λ is a weight factor used for balancing the significance of maximizing the greenhouse gas emission reduction and minimizing the prediction error (E); M is a constraint that reflects the maximum allowable total amount of greenhouse gas emission related to the power consumed by the electric vehicle according to the charging schedule, taking into account the environmental factors. The system model of the present disclosure integrates the MILP optimized charging plan and RL adaptation strategy, and includes the environmental factors such as the climate factor and the charging pile failure rate. In addition, the constraints of the system model of the present disclosure ensure that the total emissions related to the consumed electricity comply with the predetermined environmental constraints and considerations factors.

The system framework design of the present disclosure is a system framework (MRT-framework) that integrates MILP, RL and TL technologies to optimize the electric vehicle charging schedule of the charging station while maximizing greenhouse gas savings. Considering charging costs and accurately predicting greenhouse gas reduction, the system architecture is designed as shown in FIG. 1, and the present disclosure includes:
a mixed-integer linear programming (MILP) optimization module 1, for inputting usage data of at least one charging facility, and the mixed-integer linear programming (MILP) optimization module 1 can optimize the charging behavior of the electric vehicle in the charging station based on the data and limitation of the known usage data such as at least one of the available capacity, charging rate, remaining capacity, charging price, and greenhouse gas emission of the charging facility, and can find the best charging schedule to maximize the greenhouse gas reduction;
a reinforcement learning (RL) module 2, mainly provided for using reinforcement learning (RL) to adapt charging, and inputting charging data (such as the failure rate or charging price of a charging facility) and climate condition of the charging facility, so as to correspondingly adjust the charging schedule according to the interactivity of the charging data and climate condition;
a climate prediction module 3, for inputting meteorological data collected at the location of the charging facility, so as to predict the meteorological change occurred at the location of the charging facility according to time sequence, wherein the predicted meteorological data factor can be provided by the meteorological forecast and can integrate the climate conditions to change the dynamic learning environment of the reinforcement learning (RL) module 2 and adjust the charging schedule accordingly;
an electric vehicle charging capacity prediction module 4, for inputting charging demand data of the charging facility, so as to predict the charging demand of the charging facility according to time sequence, and correspondingly generate a charging prediction information;
a transfer learning (TL) module 5, for integrating the outputs of the mixed-integer linear programming (MILP) optimization module 1 and the reinforcement learning (RL) module 2, using the charging prediction information as a supplementary variable, and correspondingly predicting the greenhouse gas reduction; and wherein the electric vehicle charging capacity prediction module 4 is in a transfer learning (TL) module 5, which is a new prediction model for training; and the transfer learning (TL) module 5 can integrate the insights obtained from the electric vehicle charging capacity prediction module 4 to develop a multivariable time prediction model in order to predict the greenhouse gas savings in the electric vehicle charging, and these supplementary variables encapsulate the dynamic scheduling decisions affected by the RL agent operation based on the MILP solution, thereby overcoming the problem of applicable data set limitations and improving the accuracy of predicting greenhouse gas reduction associated with electric vehicle charging by converting the knowledge of predicted electric vehicle charging capacity into predicted greenhouse gas reduction, while accelerating the training of each model;
an integration and control module 6, connected to the mixed-integer linear programming (MILP) optimization module 1, the reinforcement learning (RL) module 2, the climate prediction module 3, the electric vehicle charging capacity prediction module 4 and the transfer learning (TL) module 5, for adjusting the charging schedule based on the usage data, charging data, meteorological data, charging demand data, charging prediction information, supplementary variable and predicted greenhouse gas reduction of the charging facility, while achieving the following objectives by integration, coordination and optimization:
1. Model Coordination: It ensures the coordination of the output of each module.
2. Data Integration: It integrates the data sets required by different modules to maximize the use of resources and information.
3. Dynamic Adjustment: It adjusts the operation of each module based on real-time information, especially the changes in charging facility status or energy supply in meteorological data, usage data, and charging data.
4. Performance Optimization: It maximizes system performance, including reducing charging-related greenhouse gas emissions, minimizing costs, and fulfilling charging demand.

The existence of the integration and control module 6 can improve the overall performance of the system, ensure smooth collaboration between modules, and quickly make adjustments with changes of various factors to achieve the goal of optimization.

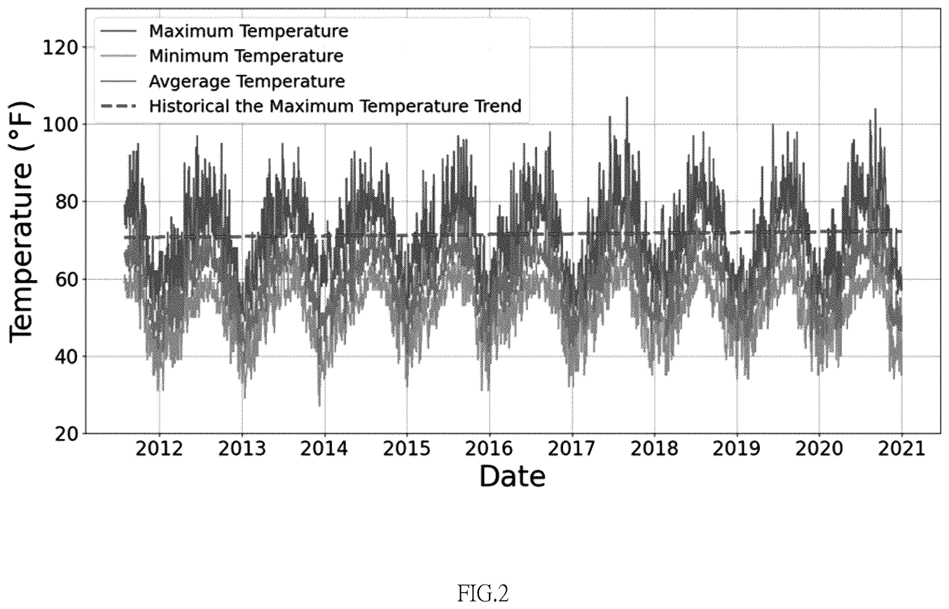

The present disclosure uses historical data and local weather records about the usage of electric vehicle (EV) charging stations in Palo Alto, California, and the data set includes the usage data of electric vehicle charging stations in Palo Alto from 2012 to 2021. In addition, the transfer learning (TL) technology is integrated to improve the accuracy of predicting the greenhouse gas reduction of the electric vehicle charging stations, as shown in FIG. 2, which shows the changes in daily temperatures in Palo Alto from 2012 to 2021 (including maximum temperature, minimum temperature and average temperature changes). Observations of the trend lines reveal the increasing trajectory of maximum temperatures over the years, emphasizing the impact of global warming on the climate;

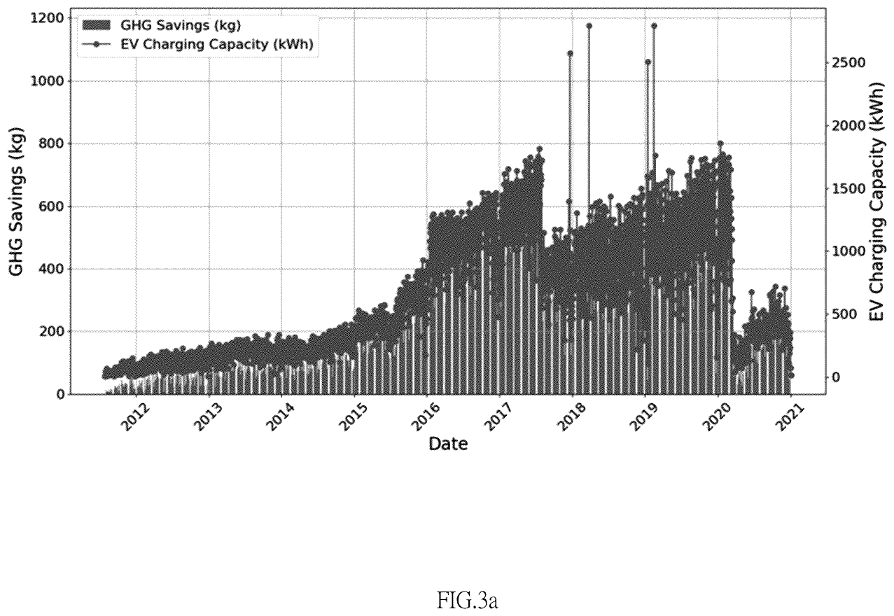

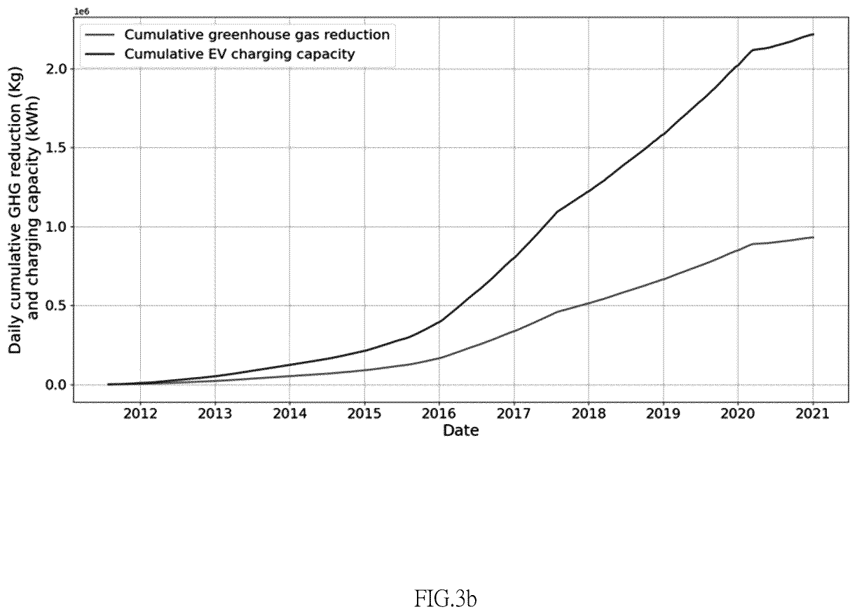

With reference to FIGS. 3a and 3b for the historical change in the amount of greenhouse gas reduction from electric vehicle charging in Palo Alto, California, USA from 2012 to 2021, FIG. 3b shows the cumulative electric vehicle charging capacity within the same time period in Palo Alto, elaborating the historical change of the charging capacity and cumulative saving in greenhouse gas emissions. It can be seen that the increase in charging capacity proportionally increases with the greenhouse gas reduction; and conversely, the decrease in charging capacity correspondingly decreases with the greenhouse gas reduction.

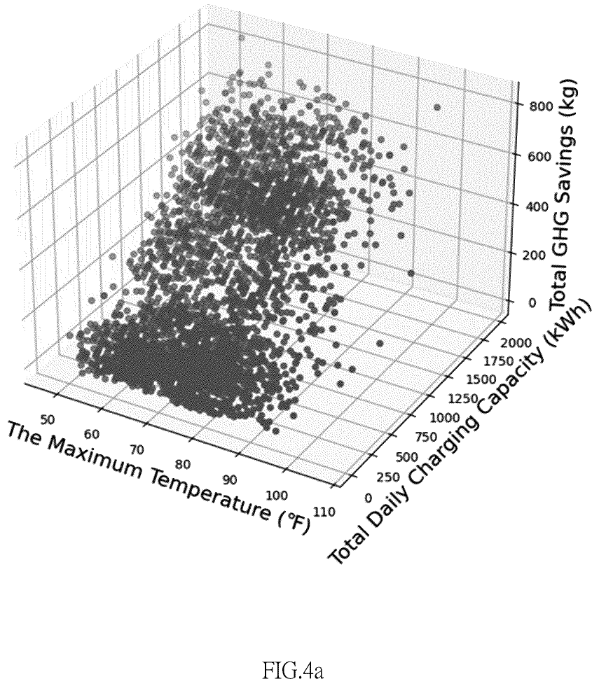

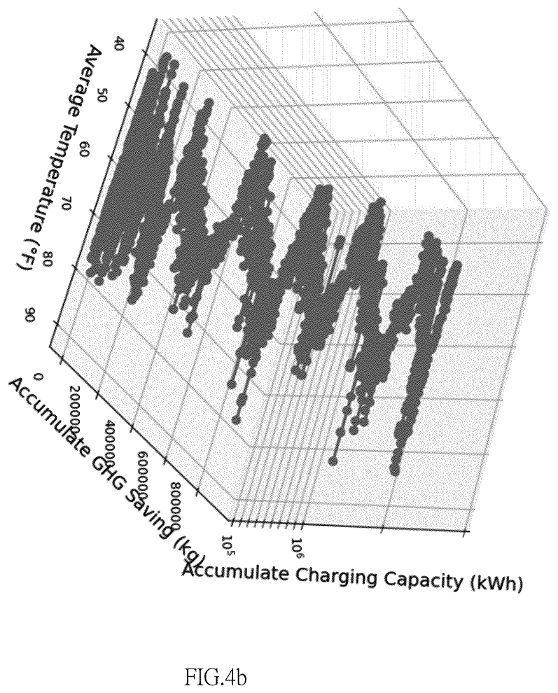

In this embodiment, an in-depth analysis of the impact of environment climate change and the number of electric vehicle charging on climate change and the impact of the number of electric vehicle charging on the reduction of greenhouse gas emission from electric vehicles are conducted. With reference to FIGS. 4a and 4b for the relationship between temperature changes in greenhouse gas reduction and electric vehicle charging capacity in Palo Alto, California from 2012 to 2021, FIG. 4b shows the interaction between the historical average temperature, electric vehicle charging capacity and the cumulative greenhouse gas reduction. This observation shows that the increase in environmental temperature and the increase in electric vehicle charging demand have a significant impact on the greenhouse gas reduction.

### [Mixed-Integer Linear Programming (MILP) Optimization Module 1 for Optimizing Electric Vehicle Charging]

In order to minimize greenhouse gas emission and maximize the extent of satisfying the electric vehicle charging demand of electric vehicle owners, while considering the electric vehicle charging cost, the present disclosure determines the optimal charging schedule of each electric vehicle at different time intervals through the setting of the mixed-integer linear programming (MILP) optimization module 1. To formulate a mathematical model for the electric vehicle owners' problem of minimizing greenhouse gas emission and maximizing the extent of satisfying the electric vehicle charging demand using MILP, this embodiment consider a multiple of electric vehicles, different charging stations, variable electricity prices and other related factors. The target function f(x) that minimize the total greenhouse gas emissions while satisfying the charging demand is given in the Mathematical Equation 2 below:

$$[ Mathematical Equation 2 ]$$

$$f ( x ) = Minimize {{\sum }_{i = 1}}^{N} {\sum }_{j = 1}^{K} {\sum }_{t = 1}^{M} ( {C}_{emissions} ( t ) \cdot {X}_{ijt} \cdot {P}_{t} )$$

where, Cₑₘᵢₛₛᵢₒₙₛ (ton) represents the carbon emissions associated with electricity generation (kg/kWh) at the time t; Xᵢⱼₜ is a decision variable, which is a non-negative variable standing for the amount of electricity (kWh) charged to electric vehicle i at the charging station j in the time interval t, and is expressed in the Mathematical Equation 3 below:

$$[ Mathematical Equation 3 ]$$

$${X}_{ijt} \geq 0 ∀ i = 1 , … , N , j = 1 , … , K , t = 1 , … , M$$

Where, Pt is the charging price (USD/kWh) of the charging facility;

The limit of the electric vehicle charging demand can be expressed by the Mathematical Equation 4 below to ensure that the charging demand of each electric vehicle is met, where cₙ_{ᵢ} is the charging capacity required by the electric vehicle i.

$$[ Mathematical Equation 4 ]$$

$${{\sum }_{i = 1}}^{N} {\sum }_{j = 1}^{K} {\sum }_{t = 1}^{M} {X}_{ijt} \geq {{C}_{n}}_{i} ∀ i$$

In addition, the charging capacity constraint is defined to limit the charging capacity of each charging station at each time interval, and the capacity limit of the charging station can be expressed by the Mathematical Equation 5 below, that is, the charging demand of the electric vehicle will not exceed the capacity limit of the charging station.

$$[ Mathematical Equation 5 ]$$

$${{\sum }_{i = 1}}^{N} {\sum }_{j = 1}^{K} {\sum }_{t = 1}^{M} {X}_{ijt} \leq {S}_{j} ∀ j , t$$

where, Sⱼ is the maximum capacity of charging station j;

A binary variable Yⱼₜ can be introduced to represent whether charging station is used within a specific time interval, and its expression is shown in the Mathematical Equation 6 below:

$$[ Mathematical Equation 6 ]$$

$${Y}_{jt} ∈ \{ 0 , 1 \} ∀ j , t$$

According to the Mathematical Equations 5 and 6, the charging station activation constraint can be defined by the Mathematical Equation 7 below to ensure that the charging station is considered to have been used only if there is at least one electric vehicle charged in the charging station.

$$[ Mathematical Equation 7 ]$$

$${{\sum }_{i = 1}}^{N} {\sum }_{j = 1}^{K} {\sum }_{t = 1}^{M} {X}_{i j t} \geq {S}_{j} \cdot {Y}_{j t} ∀ j , t$$

In this way, we can adjust the target function to consider the binary variable and electric vehicle charging price. The modified mixed-integer linear programming (MILP) function f(x) is shown in the Mathematical Equation 8 below, as proposed by the present disclosure and based on the mixed-integer linear programming (MILP) optimization module 1, the trade-off between charging demand, site capacity, electricity price and greenhouse gas emission can also be considered to provide the best charging schedule for electric vehicles in order to minimize greenhouse gas emission, while satisfying the electric vehicle charging demand.

$$[ Mathematical Equation 8 ]$$

$$f ( x ) = Minimize ( {{\sum }_{i = 1}}^{N} {\sum }_{j = 1}^{K} {\sum }_{t = 1}^{M} {C}_{emissions} ( t ) \cdot {X}_{ijt} \cdot {P}_{t} + {\sum }_{j = 1}^{K} {\sum }_{t = 1}^{M} {P}_{t} \cdot {Y}_{jt} )$$

[Realization of Dynamic Environmental Adaptation of Electric Vehicle Charging by Integrating Climate Prediction into Reinforcement Learning (RL)]

In this embodiment, it is assumed that the climate prediction module 3 has trained a time sequence prediction model, which can predict meteorological changes at multiple time steps in the future, including variables such as temperature, rainfall, humidity, and wind speed; climate prediction module 3. The expected results of the climate prediction module 3 will be provided to the reinforcement learning (RL) module 2 for subsequent analysis and use.

In the reinforcement learning (RL) module 2 of this embodiment, a learning function is designed based on the Q learning algorithm, aiming to improve the charging schedule based on real-time environmental dynamics and feedback. The RL agent is specifically designed to guide the Q-learning algorithm to adapt to dynamic conditions such as climate factors and electric vehicle charging pile failure, thereby enabling consistent and instant decision-making related to the MILP charging schedule. The RL agent is rewarded based on greenhouse gas reduction and learns to adjust the charging schedule accordingly. In the reinforcement learning (RL) module 2, the expected greenhouse gas emission is minimized by actively adjusting the charging schedule to cope with the predicted climate change and potential electric vehicle charging pile failure. The RL agent acquires knowledge through the learning function, estimates the expected future accumulated greenhouse gas reduction for a given action in a given state.

Specifically, the learning function defines a state space and an action parameter, the state space is a combination of the charging data and the corresponding climate condition, and the action parameter is provided for adjusting the charging schedule;

The state space (Sₜ) can be defined as a combination of climate condition (CF) and charging data (this embodiment includes charging pile failure (F) as an example), which can be expressed in the Mathematical Equation 9 below:

$$[ Mathematical Equation 9 ]$$

$${S}_{t} = \{ ( {CF}_{1 t} , {CF}_{2 t} , … , {CF}_{it} , {F}_{1 t} , {F}_{2 t} , … , {F}_{j t} ) \}$$

which is a multidimensional state space, wherein C_{fit} stands for the i^{th} climate factor obtained at the time t, and Fⱼₜ stands the j^{th} charging facility failure occurred at the time t.

The action parameter Aₜ represents the adjustment of the charging schedule, which can be the change of the charging rate of a specific electric vehicle at a specific charging station and in a specific time interval, and it is defined in the Mathematical Equation 10 below:

$$[ Mathematical Equation 10 ]$$

$${A}_{t} = \{ ( i , j , i , Δ {X}_{ijt} ) \}$$

where, ΔXᵢⱼₜ represents the adjustment of the charging capacity of the electric vehicle i at the charging station j during the time interval t.

The learning function is expressed as Q(Sₜ, Aₜ), let it be the Q value of a given state-action pair, and its definition is given in the Mathematical Equation 11 below:

$$[ Mathematical Equation 11 ]$$

$$Q ( {S}_{t} , {A}_{t} ) = 𝔼 [ {R}_{t + 1} + γ {max}_{{A}_{t + 1}} Q ( {S}_{t + 1} , {A}_{t + 1} ) \vert {S}_{t} , {A}_{t} ]$$

where, where, Rₜ₊₁ is a reward factor of the greenhouse gas reduction at the time t+1; and γ is a discount factor that controls the significance of future rewards.

The strategy function π(Sₜ) defines the strategy program for the agent to select operations in a given state, which is a function mapping states to operations. In this case, the strategy function can minimize the greenhouse gas emission, and it is defined in the Mathematical Equation 12 below:

$$[ Mathematical Equation 12 ]$$

$$π ( {S}_{t} ) = arg {max}_{{A}_{t}} Q ( {S}_{t} , {A}_{t} )$$

The reinforcement learning (RL) agent balances exploration and exploitation by using the epsilon-greedy method, let ϵ be the exploration rate, π(s) be the strategy for selecting actions in the state s, and the strategy π(s) uses the probability 1−ϵ (exploitation) to select the operation with the highest Q value and the random operation (exploration) with the probability ϵ, which can be expressed as the Mathematical Equation 13 below:

$$[ Mathematical Equation 13 ]$$

$$π ( s ) = \{ \begin{matrix}arg {max}_{{A}_{t}} Q ( {S}_{t} , {A}_{t} ) & with probability 1 - ϵ \\ random action & with probability ϵ\end{matrix}$$

As far as the reward function is concerned, the reward function Rᵢₜ can be set to represent the reward of the electric vehicle i obtained from the RL agent strategy at the time t, and the reinforcement learning (RL) updates the RL agent strategy to maximize the expected cumulative reward, while taking into account the predicted greenhouse gas reduction Epredt, as shown in the Mathematical Equation 14 below:

$$[ Mathematical Equation 14 ]$$

$${R}_{it} = {\sum }_{t = 1}^{M} {E}_{{pred}_{i}} - λ \times {\sum }_{t = 1}^{M} {X}_{ijt} , ∀ i = 1 , … , N , \\ j = 1 , … , K , t = 1 , … , M$$

where, λ is an adjustment parameter, used to balance the trade-off between the emission reduction and the reward of the RL agent strategy. It allows us to control the impact of emission prediction on the RL agent decision-making.

The update rule of the learning function is shown in the Mathematical Equation 15 below, where a is the learning rate, and the expected cumulative future greenhouse gas reduction of different adjustments to the charging schedule can be estimated based on the environmental conditions and historical experience.

$$[ Mathematical Equation 15 ]$$

$$Q ( {S}_{t} , {A}_{t} ) ← Q ( {S}_{t} , {A}_{t} ) + α [ {R}_{t + 1} + γ {max}_{{A}_{t + 1}} Q ( {S}_{t + 1} , {A}_{t + 1} ) - Q ( {S}_{t} , {A}_{t} ) ]$$

### [Transfer Learning (TL) for Predicting Emissions]

The application of transfer learning (TL) to greenhouse gas reduction prediction during electric vehicle charging has several major advantages; firstly, it utilizes the knowledge gained from a pre-trained model for predicting charging demand, thereby leveraging existing data and obtained representations, this approach reduces the need to conduct extensive data collection and training from scratch, and therefore, by transferring knowledge gained from one domain (charging demand prediction) to another (greenhouse gas reduction) to speed up model development and improve prediction accuracy. In addition, the transfer learning (TL) helps adapt to the specific characteristics of greenhouse gas reduction, while mitigating the risk of overfitting by utilizing common characteristics learned during pre-training to reduce data requirements, accelerate model development and prediction accuracy and potentially improve the advantages to make the transfer learning (TL) a valuable strategy for optimizing the greenhouse gas emissions from the charging of electric vehicles.

As to the transfer learning (TL), the present disclosure uses a pre-trained neural network model in the electric vehicle charging demand prediction module, and fine-tunes the model to predict greenhouse gas emission. To ensure that the knowledge captured by the pre-trained model is preserved, we freeze existing layers, which means that their weights and biases are not updated during training, which is crucial to prevent the pre-trained model from losing its learned features. The model uses relevant inputs (such as: electric vehicle charging data, and optimized charging schedule) to predict the emissions at different time intervals. In this embodiment, Epredt is used to represent the amount of predicted greenhouse gas emissions of each electric vehicle, when the transfer learning (TL) is integrated, as shown in Mathematical Equation 16 below:

$$[ Mathematical Equation 16 ]$$

$${E}_{{pred}_{t}} = {\sum }_{j = 1}^{K} {\sum }_{t = 1}^{M} {C}_{emissions} \cdot {P}_{t} \cdot {X}_{ijt} + {b}_{i} ∀ t = 1 , … , T$$

Therefore, the present disclosure modifies the strategy of the RL agent to consider the emission prediction of the transfer learning (TL) model. This step is crucial for optimizing the charging schedule while considering the predicted emission, and minimizing the total amount of greenhouse gas emissions, while satisfying the charging demand, integrating the transfer learning (TL), and considering the strategy of the RL agent, and defines a transfer learning (TL) target function accordingly to predict the greenhouse gas reduction. A transfer learning (TL) target function is defined corresponding to the transfer learning (TL) target function F2 as shown in the Mathematical Equation 17 below:

$$[ Mathematical Equation 17 ]$$

$${F}_{2} = Minimize {\sum }_{i = 1}^{N} {\sum }_{j = 1}^{K} {\sum }_{t = 1}^{M} {C}_{emmisions} \cdot {P}_{t} \cdot {X}_{ijt} + {{\sum }^{T}}_{t = 1} {( {G}_{i} - {E}_{{pred}_{t}} )}^{2} + {{\sum }^{N}}_{i = 1} {\sum }_{t = 1}^{M} {X}_{ijt} \cdot {E}_{{pred}_{t}} ; \qquad ( Equation 5 )$$

### Experimental Example

In this experimental example, we start from the non-optimized baseline charging schedule, and then implement the optimizer that integrates MILP and RL into the application for the charging schedule, and then compare the greenhouse gas reduction percentage and the charging cost achieved through this optimization process. The greenhouse gas reduction is calculated by the Mathematical Equation 18, and the cost saving is calculated by Mathematical Equation 19 as shown below:

$$[ Mathematical Equation 18 ]$$

$$Emission Reduction \% = \frac{Baseline Emissions - Optimized Emissions}{Baseline Emissions} \times 100 \%$$

where, the baseline emissions are the amounts of baseline greenhouse gas emissions, and the optimized emissions are the amounts of the optimized greenhouse gas emissions.

$$[ Mathematical Equation 19 ]$$

$$Cost Saving \% = \frac{Non ‐ optimized Charging Expenses - Optimized Charging Expenses}{Non ‐ optimized Charging Expenses} \times 100 \%$$

where, the non-optimized charging expenses are the non-optimized charging costs, and the optimized charging expenses are the optimized charging expenses.

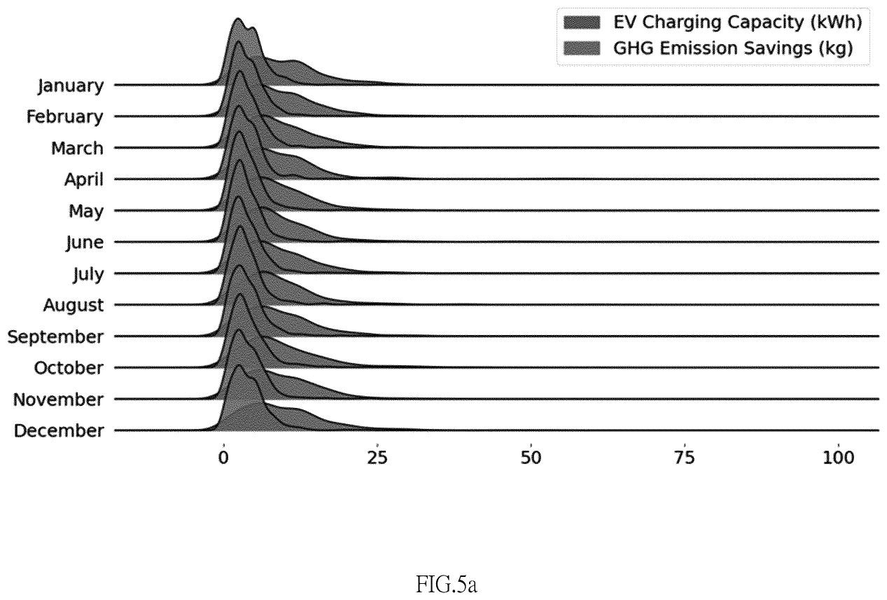

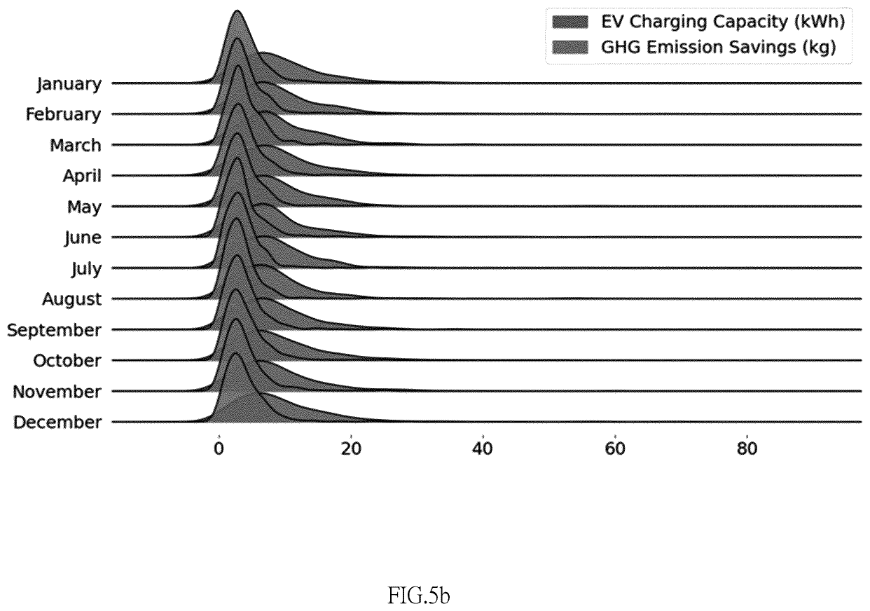

FIGS. 5a and 5b show the monthly changes in total electric vehicle charging capacity and greenhouse gas reduction before (as shown in FIG. 5a) and after (as shown in FIG. 5b the implementation of an optimized electric vehicle charging plan at Palo Alto CA/BRYANT #1 charging station). Obviously, compared with the situation without optimizing the charging schedule, the present disclosure that integrates MILP and RL to optimize the charging schedule can significantly increase the monthly total electric vehicle charging capacity and greenhouse gas reduction of the charging station.

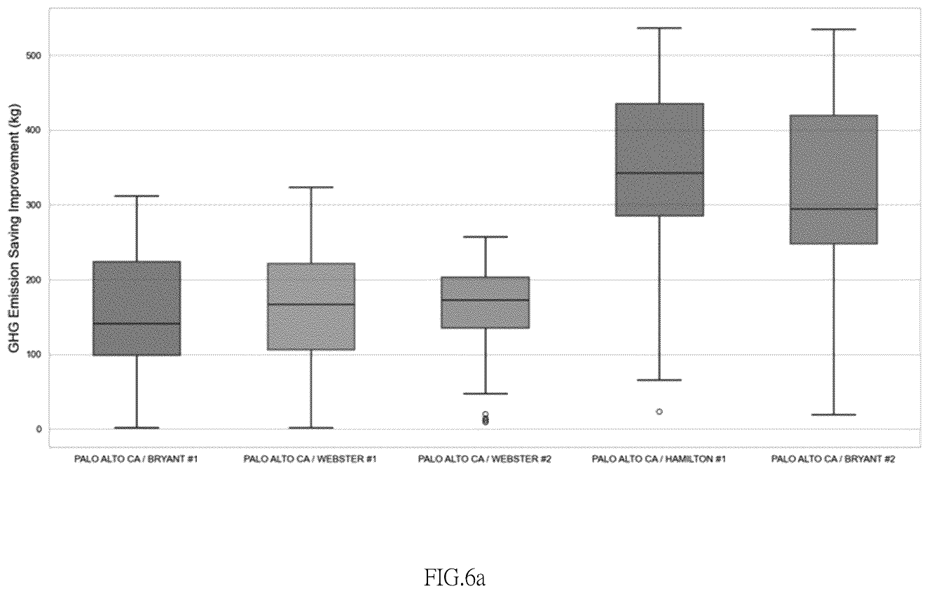

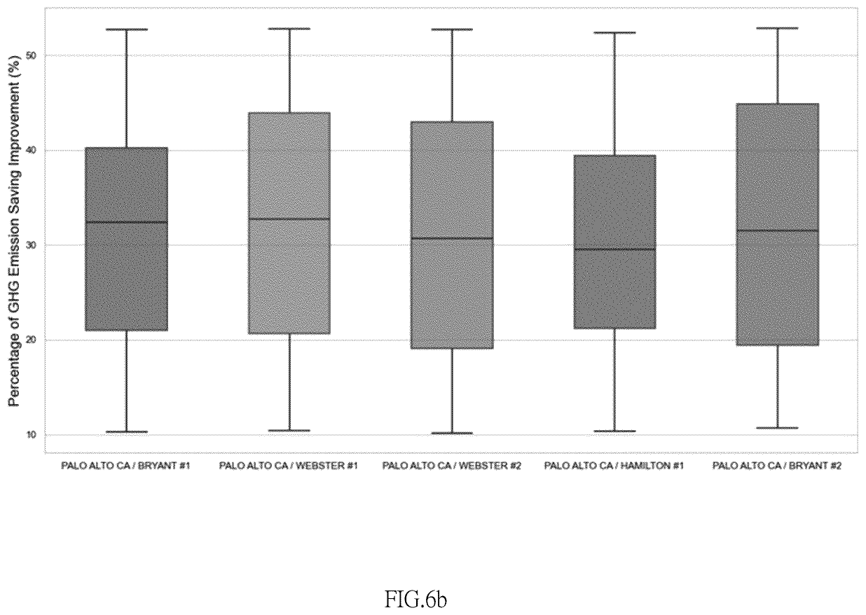

With reference to FIGS. 6a and 6b for the achieved greenhouse gas reduction (as shown in FIG. 6a) and emission reduction percentage (as shown in FIG. 6b), after optimizing the electric vehicle charging schedule for the top five charging stations, the research results show that by applying the method of the present disclosure to optimize the electric vehicle charging schedule, the average greenhouse gas emission of these charging stations is reduced by 258.74 kilograms (31.57%), and can be reduced by up to 671.62 kilograms (52.87%).

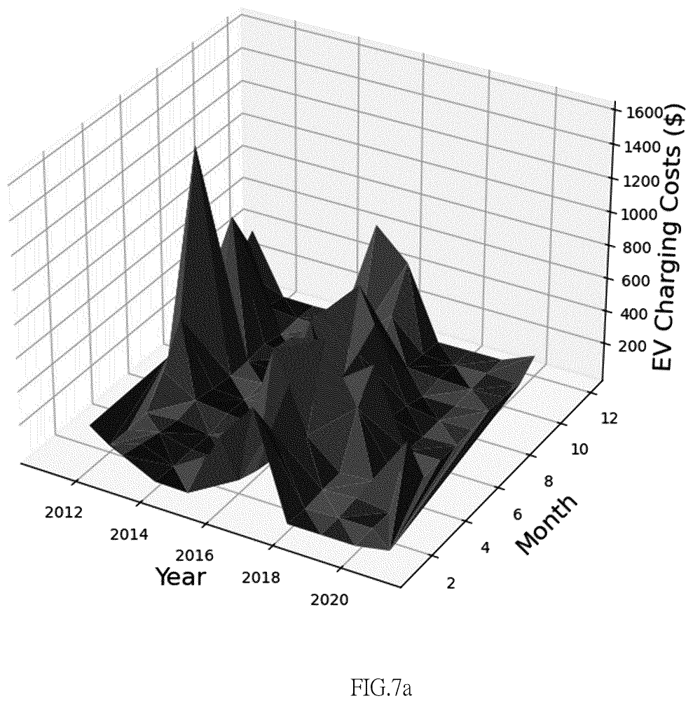

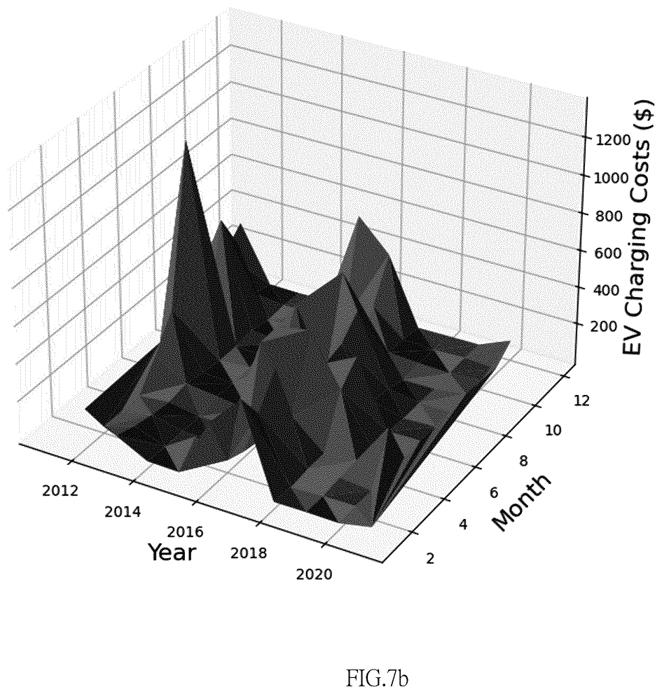

With reference to FIGS. 7a and 7b for the comparison of the charging costs of all electric vehicle users under optimized charging schedule and non-optimized charging schedule respectively, FIG. 7a shows that the charging costs incurred by all electric vehicle users in the case without applying optimization. In comparison, FIG. 7b shows the charging costs after applying the optimization method based on MILP-RL of the present disclosure. It can be seen that by applying the present disclosure, the overall charging cost for electric vehicle users is significantly reduced. Before optimization, the total cost for all users was US$4,659,369.7. However, through optimization, the cost dropped significantly to US$3,542,016.5, resulting in a total saving of US$1,117,353.2.

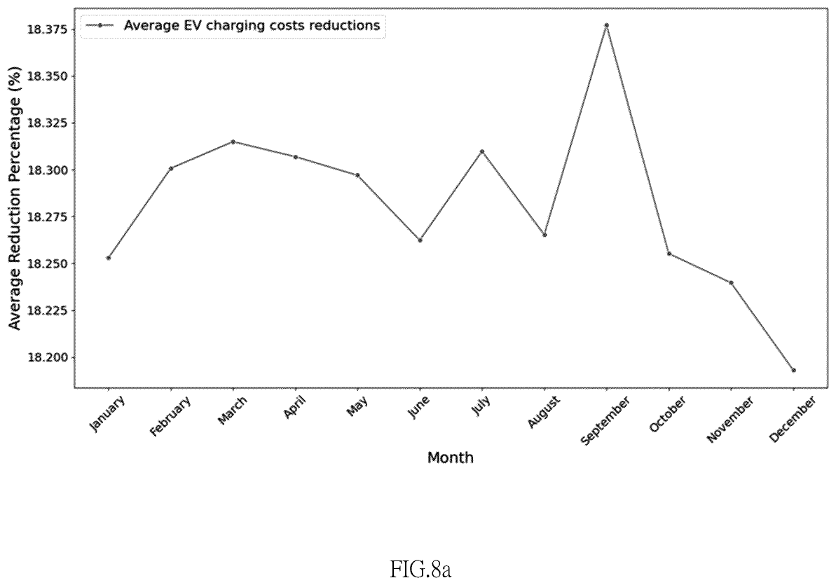

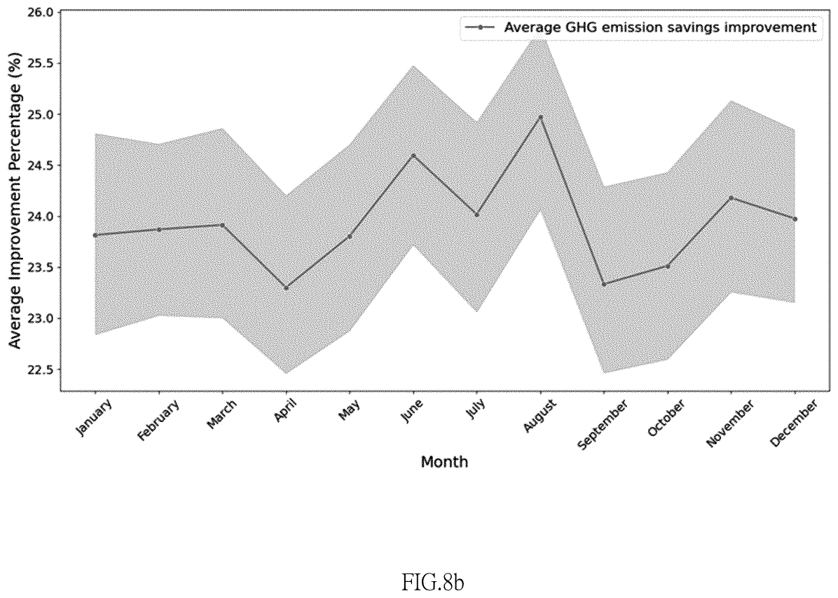

With reference to FIGS. 8a and 8b for the percentage of reduction in the average monthly charging cost and the amount of greenhouse gas emission saved by all users after implementing the optimized charging schedule of in the present disclosure respectively, the analysis in FIG. 8a shows that the highest user cost savings occurred in September, which was approximately 18.38%. In addition, the charging cost of all users is reduced by at least 18.19%. At the same time, FIG. 8b highlights the largest improvement in the amount of greenhouse gas reduction by users in August, which is about 24.97%. It is noteworthy that the amount of all users' greenhouse gas emissions is reduced by at least 23.30%.

### [Transfer Learning (TL) for Predicting Greenhouse Gas Emission]

The present disclosure establishes a unified model architecture for scenarios with/without the transfer learning (TL) training and transfer learning (TL) training by stacking the long short-term memory (LSTM) models. For models that have been trained by transfer learning (TL), the stacked LSTM model is started by the weights or features obtained from the relevant charging capacity prediction task through the merging and optimizing the charging plan. Subsequently, the emission prediction data set is used to improve the model, and MAE, MSE, RMSE and SMAPE are recorded in the validation set.

The MAE, MSE, RMSE and SMAPE of the transfer learning (TL) model are compared with an independent model without the transfer learning (TL) to evaluate the prediction accuracy, where a lower value represents a higher accuracy, and then the percentage improvement of the four indicators between models is calculated as given in the Mathematical Equation 20 below. A higher percentage improvement means that the accuracy of emission prediction can be improved by using the knowledge of charging capacity.

$$[ Mathematical Equation 20 ]$$

$$Percentage Improvement \% = ( 1 - \frac{Metric of Transfer Learning Model}{Metric of Standalone Model} ) \times 100 \%$$

where, the Metric of Transfer Learning Model is the measured value of the transfer learning model, and the Metric of Standalone Model is the measured value of the independent model without transfer learning.

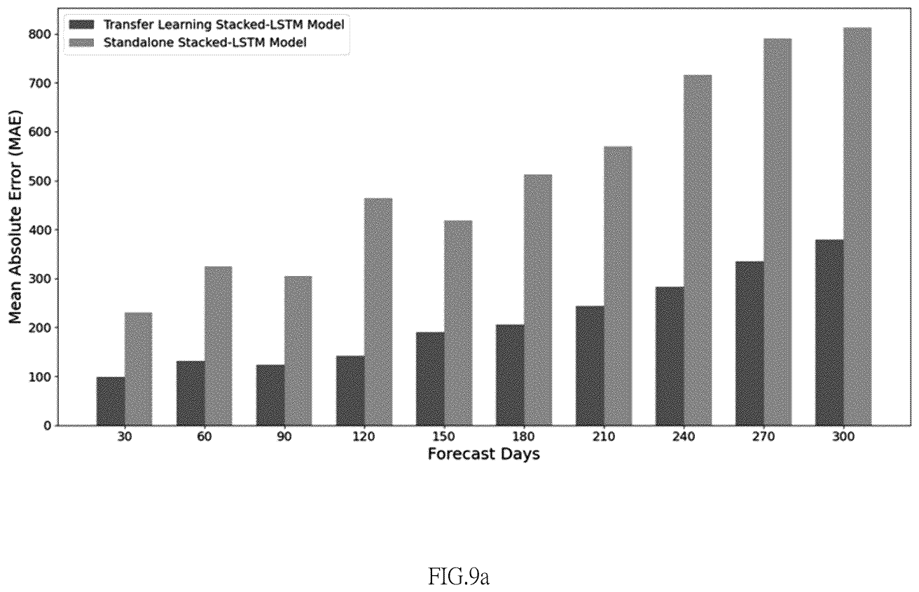

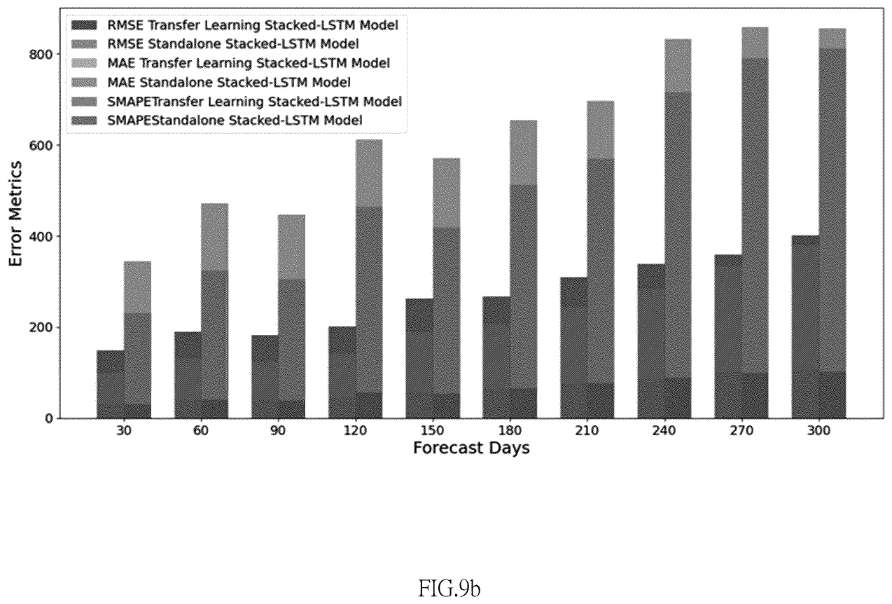

With reference to FIGS. 9a and 9b for the comparison of the prediction accuracy of the independent stacked LSTM model and the transfer learning (TL) stacked LSTM model respectively, both are trained using the MRT system framework of the present disclosure for predicting the future. amount of greenhouse gas emission on different days. In FIG. 9a, the performance of the model is compared in terms of mean absolute error (MAE); the experimental results confirm that the transfer learning (TL) stacked LSTM model is always better than the independent stacked LSTM model in predicting emissions, and has excellent accuracy in the short term (30-day) to long-term (300-day) forecast. In addition, FIG. 9b compares the performance indicators of the model, including RMSE, MAE and SMAPE, confirming that the transfer learning (TL) stacked LSTM model has higher accuracy than its independent model.

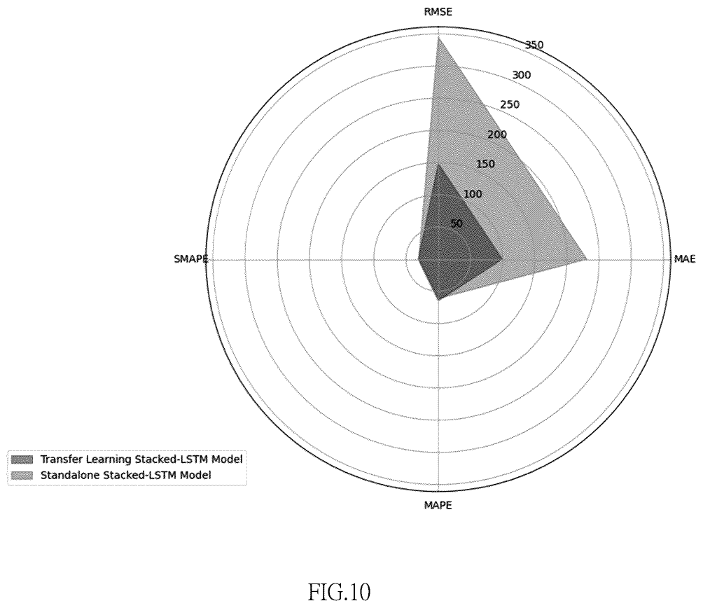

In addition, FIG. 10 presents a comprehensive evaluation of the overall performance of these models, reaffirming that the transfer learning (TL) stacked LSTM model is better than the independent stacked LSTM model in all four performance indicators; these empirical results prove the effectiveness of the MRT system framework and the significant improvement of the accuracy of greenhouse gas reduction predictions related to electric vehicle charging of the present disclosure.

### [Long Term Impact Evaluation]

In this embodiment, a baseline scenario representing the cumulative emissions and long-term costs associated with traditional charging methods is established, and historical data illustrating typical charging behavior over longer periods of time and its corresponding emissions and costs are collected. The optimal charging schedule derived from the present disclosure is expected to be used in the scenario, and these charging schedules are used to predict emissions and costs in the same period;

To calculate the accumulated greenhouse gas (GHG) emissions and the expected total charging cost during this period, the present disclosure adopts the optimized charging schedule, and then compares these expected accumulated greenhouse gas emissions and costs based on the corresponding data calculated and obtained from the baseline scenario. This comparative analysis enables us to calculate the total emissions reduction and cost savings. A higher reduction represents the environmental benefits of implementing an optimized charging schedule over the longer term; similarly, a higher cost saving means that there are economic advantages to using an optimized charging schedule over a longer period of time compared to the traditional methods.

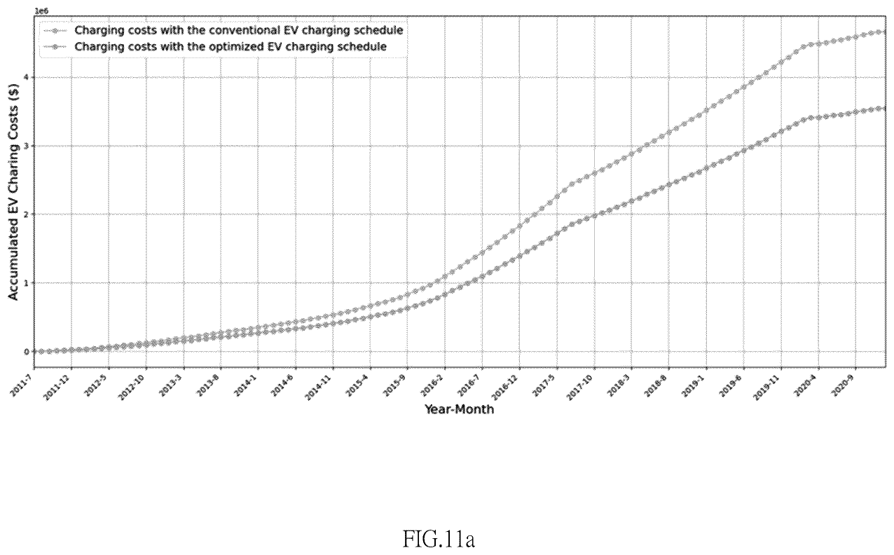

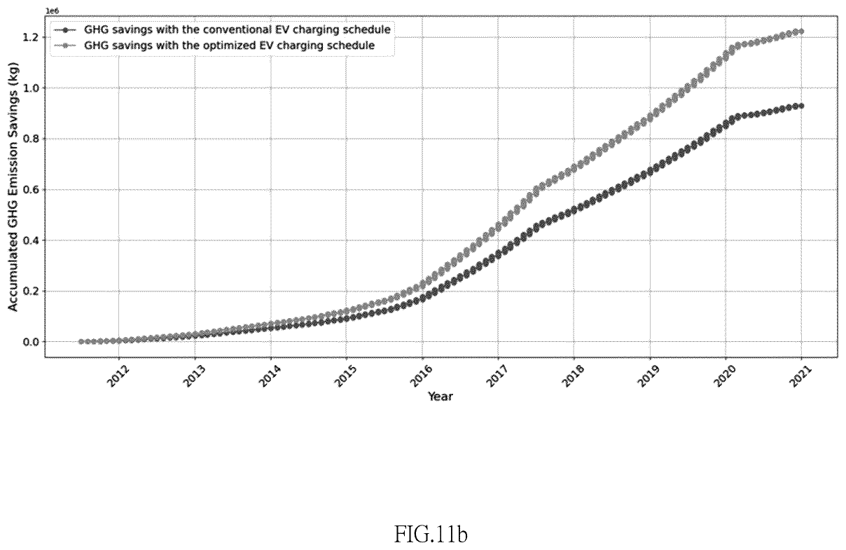

With reference to FIGS. 11a and 11b for the cumulative electric vehicle charging cost (FIG. 11a) and the cumulative greenhouse gas reduction (FIG. 11b) generated by two different charging schedules respectively, experimental results show that after optimization, the electric vehicle charging schedule of the present disclosure is always better than the traditional non-optimized charging schedule. This is reflected by the reduction in the cumulative charging cost of electric vehicles and the increase in the cumulative greenhouse gas reduction. It is noteworthy that as the observation time increases, the advantages of the present disclosure become more obvious.

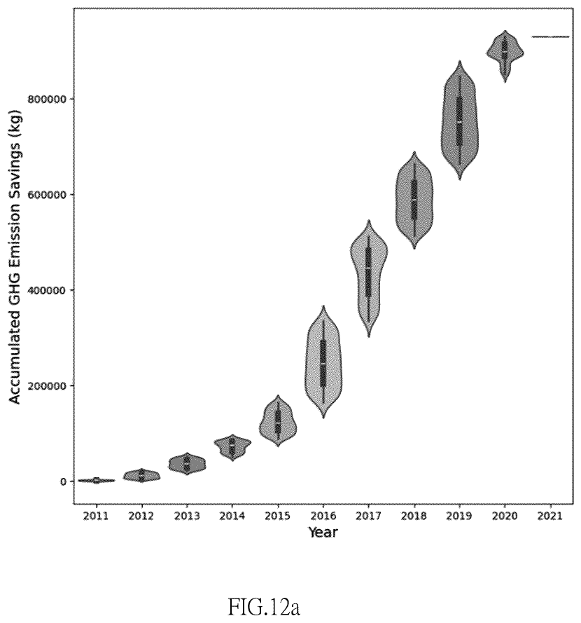

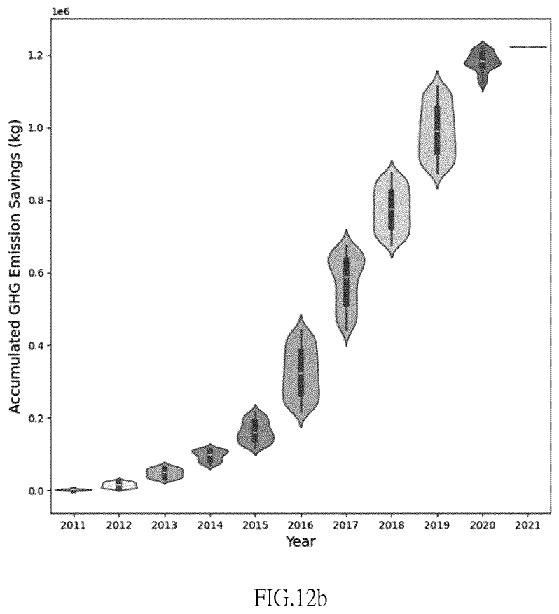

With reference to FIGS. 12a and 12b, detailed year-by-year analyses are conducted for the cumulative greenhouse gas emission reduction performance of the prior art and the present disclosure respectively, FIG. 12b shows the cumulative greenhouse gas reduction of the optimized electric vehicle charging schedule of the present disclosure, and the comparative analysis of these data shows that the optimization method of the present disclosure is indeed superior to the traditional method in terms of annual cumulative greenhouse gas reduction, thereby confirming the effectiveness of the present disclosure in reducing long-term electricity consumption costs for electric vehicle users, which contributes to the sustainability of electric vehicle infrastructure and environmental protection.

In summation, the system of the present disclosure provides a solution that not only optimizes the electric vehicle charging schedule, but also effectively improves environmental protection by curbing greenhouse gas emission and promoting the sustainable practice of electric vehicle infrastructure. efficacy, and can revolutionize the charging method of electric vehicles, reduce environmental impact, and provide the potential of sustainable energy efficiency for transportations.

What is claimed is:

1. A system for optimizing electric vehicle charging schedules and improving the accuracy of predicting greenhouse gas emissions based on transfer learning and deep reinforcement learning, comprising:
a mixed-integer linear programming (MILP) optimization module, for inputting usage data of at least one charging facility, so as to optimize the charging behavior of the charging facility and establish a charging schedule based on the reduction of greenhouse gas emissions;
a reinforcement learning (RL) module, for inputting charging data and climate conditions of the charging facility, so as to adjust the charging schedule according to the interactivity of the charging data and the climate conditions;
a climate prediction module, for inputting meteorological data collected at the location of the charging facility, so as to predict a meteorological change occurred at the location of the charging facility according to a time sequence, and integrate the climate conditions to let the reinforcement learning (RL) module dynamically adjust the charging schedule;
an electric vehicle charging capacity prediction module, for inputting charging demand data of the charging facility, so as to predict the charging demand of the charging facility according to the time sequence, and generate a charging prediction information accordingly;
a transfer learning (TL) module, for integrating the outputs of the mixed-integer linear programming (MILP) optimization module and the reinforcement learning (RL) module, using the charging prediction information as a supplementary variable, and predicting the reduction of greenhouse gas emissions; and
an integration and control module, linked to the mixed-integer linear programming (MILP) optimization module, the reinforcement learning (RL) module, the climate prediction module, the electric vehicle charging capacity prediction module and the transfer learning (TL) module, so as to adjust the charging schedule according to the usage data of the charging facility, the charging data, the meteorological data, the charging demand data, the charging prediction information, the supplementary variable and predicted greenhouse gas reduction.

2. The system for optimizing electric vehicle charging schedules and improving the accuracy of predicting greenhouse gas emissions based on transfer learning and deep reinforcement learning according to claim 1, wherein the usage data refers to at least one selected from the collection of the available capacity, charging rate, remaining capacity, charging price, and greenhouse gas emission of the charging facility.

3. The system for optimizing electric vehicle charging schedules and improving the accuracy of predicting greenhouse gas emissions based on transfer learning and deep reinforcement learning according to claim 1, wherein the charging data refers to one selected from the failure rate and the charging price of the charging facility.

4. The system for optimizing electric vehicle charging schedules and improving the accuracy of predicting greenhouse gas emissions based on transfer learning and deep reinforcement learning according to claim 1, wherein the mixed-integer linear programming (MILP) optimization module is based on a mixed-integer linear programming (MILP) function f(x) to establish the charging schedule, and the mixed-integer linear programming (MILP) function f(x) is given in Equation (1):
$$f ( x ) = ( {\sum }_{i = 1}^{N} {\sum }_{j = 1}^{K} {\sum }_{t = 1}^{M} {C}_{emissions} ( t ) \cdot {X}_{ijt} \cdot {P}_{t} + {\sum }_{j = 1}^{K} {\sum }_{t = 1}^{M} {P}_{t} \cdot {Y}_{jt} ) ; \qquad ( Equation 1 )$$
where, Cₑₘᵢₛₛᵢₒₙₛ(t) is the carbon emissions from power generation of the charging facility at the charging time t; Xᵢⱼₜ is a decision variable, which is a non-negative variable for each an electric vehicle i at the charging time t of a charging station j; Pt is the charging price of the charging facility; and Yⱼₜ is a function of whether or not the charging station j is used at the charging time t.

5. The system for optimizing electric vehicle charging schedules and improving the accuracy of predicting greenhouse gas emissions based on transfer learning and deep reinforcement learning according to claim 1, wherein the reinforcement learning (RL) module defines a learning function that defines a state space and an action parameter, the state space is a combination of the charging data and the corresponding climate condition, the action parameter is for an adjustment of the charging schedule, and the learning function responds to the amount greenhouse gas reduction when the action parameter is executed and the state space is presented.

6. The system for optimizing electric vehicle charging schedules and improving the accuracy of predicting greenhouse gas emissions based on transfer learning and deep reinforcement learning according to claim 5, wherein the learning function obtains the maximum value of the greenhouse gas reduction in the state space of the learning function by defining a reward factor and a discount factor.

7. The system for optimizing electric vehicle charging schedules and improving the accuracy of predicting greenhouse gas emissions based on transfer learning and deep reinforcement learning according to claim 5, wherein the reinforcement learning (RL) module further defines a reward function Rᵢₜ, and the reward function is given in Equation 2:
$${R}_{it} = {\sum }_{t = 1}^{M} {E}_{{pred}_{t}} - λ \times {\sum }_{t = 1}^{M} {X}_{ijt} , ∀ i = 1 , … , N , \\ j = 1 , … , K , t = 1 , … , M ; \qquad ( Equation 2 )$$
where, E_{predt} is a predicted greenhouse gas reduction; and λ is an adjustment parameter.

8. The system for optimizing electric vehicle charging schedules and improving the accuracy of predicting greenhouse gas emissions based on transfer learning and deep reinforcement learning according to claim 7, wherein the learning function Q (St, At) is given in Equation 3:
$$Q ( {S}_{t} , {A}_{t} ) = 𝔼 [ {R}_{t + 1} + γ {max}_{{A}_{t + 1}} Q ( {S}_{t + 1} , {A}_{t + 1} ) \vert {S}_{t} , {A}_{t} ] ; \qquad ( Equation 3 )$$
where, Rₜ₊₁ is a reward factor of the greenhouse gas reduction at the time t+1; and γ is a discount factor.

9. The system for optimizing electric vehicle charging schedules and improving the accuracy of predicting greenhouse gas emissions based on transfer learning and deep reinforcement learning according to claim 6, wherein the learning function updates the reinforcement learning (RL) according to Equation 4:
$$Q ( {S}_{t} , {A}_{t} ) ← Q ( {S}_{t} , {A}_{t} ) + α [ {R}_{t + 1} + γ {max}_{{A}_{t + 1}} Q ( {S}_{t + i} , {A}_{t + 1} ) - Q ( {S}_{t} , {A}_{t} ) ] ; \qquad ( Equation 4 )$$
where, α is a defined learning rate.

10. The system for optimizing electric vehicle charging schedules and improving the accuracy of predicting greenhouse gas emissions based on transfer learning and deep reinforcement learning according to claim 4, wherein the transfer learning (TL) module defines a transfer learning (TL) target function to predict the greenhouse gas reduction; and the transfer learning (TL) target function F₂ is given in Equation 5:
$${F}_{2} = {\sum }_{i = 1}^{N} {\sum }_{j = 1}^{K} {\sum }_{t = 1}^{M} {C}_{emissions} \cdot {P}_{t} \cdot {X}_{ijt} + {\sum }_{t = 1}^{T} {( {G}_{t} - {E}_{{pred}_{t}} )}^{2} + {\sum }_{i = 1}^{N} {\sum }_{t = 1}^{M} {X}_{ijt} \cdot {E}_{{pred}_{t}} ; \qquad ( Equation 5 )$$
where, E_{predt} is the predicted amount of greenhouse gas emissions of each electric vehicle i.
